(19) United States
(12) Patent Application Publication
(10) Pub. No.: US 2014/0346328 A1
(43) Pub. Date: Nov. 27, 2014

(54) EXTENDED DEPTH OF FIELD THREE-DIMENSIONAL NANO-RESOLUTION IMAGING METHOD, OPTICAL COMPONENT, AND IMAGING SYSTEM

(71) Applicant: SHENZHEN UNIVERSITY, Shenzhen (CN)

(72) Inventors: Hanben Niu, Shenzhen (CN); Bin Yu, Shenzhen (CN); Danni Chen, Shenzhen (CN); Heng Li, Shenzhen (CN)

(21) Appl. No.: 14/128,316

(22) PCT Filed: Jun. 26, 2013
(86) PCT No.: PCT/CN2013/078029

§ 371 Date: Dec. 20, 2013

(30) Foreign Application Priority Data
Nov. 19, 2012 (CN) 201210467807.7

(51) Int. Cl. G02B 5/18; G01N 21/64; G01N 21/84

(52) U.S. Cl. CPC G02B 5/1842; G01N 21/84; G01N 21/6447; G01N 21/6486; G02B 5/189
USPC 250/225; 250/216; 359/570

(57) ABSTRACT

An extended depth of field three-dimensional nano-resolution imaging method includes: creating an optical module with a double helix point spread function and multi-stage imaging properties of a defocus optical grating; obtaining double helix image of a molecule by imaging a molecule using the optical module; determining a lateral position of the molecule according to a position of a midpoint of double helix sidelobes on the imaging plane in the double helix image; determining an axial position of the molecule according to a rotation angle of a line of centers of the double helix sidelobes on the imaging plane and the position of the midpoint of the double helix sidelobes on the imaging plane in the double helix image. The double helix point spread function and the defocus optical grating multi-stage imaging are combined to implement three-dimensional imaging to extended the depth of field and to improve the resolution.

### CROSS-REFERENCE TO RELATED PATENT APPLICATIONS

This application is a U.S. National Phase Application under 35 U.S.C. §371 of International Patent Application No. PCT/CN2013/078029, filed Jun. 26, 2013, and claims the benefit of Chinese Patent Application No. 201210467807.7, filed Nov. 19, 2012, all of which are incorporated by reference herein.

### FIELD OF THE INVENTION

The present invention relates to microscopic imaging technology, and more particularly, to an extended depth of field three-dimensional nano-resolution imaging method, optical component, and imaging system.

### BACKGROUND OF THE INVENTION

A cell is the basic unit of organisms and life activities, in-depth study on cell is the key to uncover the mysteries of life, improve life and conquer disease. Molecule imaging under intact cell to obtain the subcellular fine structure and even the molecule profiling and to obtain information of the structural changes and molecular dynamic process under the living cell is always an important research direction. Meanwhile, making nano-resolution three-dimensional structure and function imaging with the intact cell so as to understand the change relationships and laws of subcellular structure and cell function at a higher level is the urgent needs of the life sciences and also a major challenge for imaging science.

In recent years, the far field nano-resolution fluorescence microscopic imaging technology has made great development. At present, there are two kinds most prominent methods, one kind of the method is based on reducing the effective excitation spot to improve the resolution by reducing the half width of the point spread function, including STED, GSD etc.; another method is the single molecule localization technique based on, including STORM and PALM etc. In the former method, the fluorescence effective emission area is compressed by an excited state or ground state depletion; In the latter method, switch effect is labeled by fluorescence, so that the nano-resolution imaging is achieved by sparse excitation, time imaging, centroid localization and image synthesis, a lateral spatial resolution of 20 nm has been achieved.

However, making nano-resolution three-dimensional imaging to a cell of diameter of 10 μm or more by single molecule localization technique still has many problems. Firstly, the single molecule localization does not improve the axial resolution and needs to combine certain methods of improve the axial resolution, such as cylindrical mirror astigmatism method, double helix point spread function method (DH-PSF), double plane detection method, the virtual space super resolution microscopic (VVSRM), which can achieve a three-dimensional imaging of horizontal spatial resolution of about 20-30 nm, and a axial resolution of 40-70 nm, at present, the extend of imaging of these methods is only 2 μm. In addition, the interference photosensitive interferometric photoactivated localization microscopy (iPALM) may improve the three-dimensional resolution to 20 nm or less, but the imaging range is only limited under the 500 nm of the cover glass, therefore, the imaging extend of these methods are small.

The intracellular dynamic imaging need to simultaneously track a plurality of molecules with in a cell, the imaging method is desired to quick detect the plurality of molecule targets within the dozen microns depth of field in three-dimensional space with nano positioning accuracy. The current single particle tracking (SPT) method can not only make partial detection to the sample only containing the target molecule region, to achieve fluorescence imaging with one-nanometer accuracy (FIONA); but also can adopt a wide field imaging method to simultaneous track multiple molecules. Although the SPT method of wide field detection has been developed a variety of axial resolution method such as image stack, defocused imaging, surround the particle movement with a focused laser beam, Fresnel particle tracking (FPT), as well as cylindrical mirror astigmatism method and so on, these methods already achieve three-dimensional nano positioning, but only achieve 3 μm imaging depth, while the thickness of intact cells generally are ten microns, therefore, current methods can not meet the demand of extended depth of field of the tracking of a plurality of molecules within the cell.

### SUMMARY OF THE INVENTION

The present invention provides an extended depth of field three-dimensional nano-resolution imaging method so as to solve the problems that the imaging depth of the traditional methods of is small, which can not meet the demand of extended depth of field of molecule localization.

The embodiment of the invention is realized as follows, an extended depth of field three-dimensional nano-resolution imaging method, the method includes: creating an optical module with a double helix point spread function and multi-stage imaging properties of defocus optical grating; obtaining a double helix image of a molecule to be measured by imaging a molecule to be measured using the optical module; determining a lateral position of the molecule to be measured according to a position of a midpoint of double helix sidelobes on the imaging plane in the double helix image; determining an axial position of the molecule to be measured according to a rotation angle of line of centers of the double helix sidelobes on the imaging plane and the position of the midpoint of the double helix sidelobes on the imaging plane in the double helix image.

Another purpose of the present invention is to provide an optical component used for extended depth of field three-dimensional nano-resolution imaging, the optical component comprise elements arranged in order along the transmission direction of the optical path: a first lens, used for collimating light beams emitted from the molecule to be measured; an optical module, having a double helix point spread function and multi-stage imaging properties of defocus optical grating and used for converting the light beams to imaging light beams with double helix and multi-stage imaging properties; a second lens used for outputting the imaging light beams to image.

The other purpose of the present invention is to provide an extended depth of field super-resolution fluorescence microscopic imaging and detecting system, the system comprises elements arranged in order along the transmission direction of the optical path: a probing objective lens used for receiving fluorescence beams emitting from the molecule to be measured; a light filter, used for filtering the beams and then output the fluorescence; a dichroic mirror, used for reflecting the fluorescence; an imaging component, adopting the above optical component, used for converting the fluorescence beams to imaging beams with double helix and multi-stage imaging properties; a tube lens used for focusing the reflected fluorescence and transferred to the imaging component; a detector used for receiving the imaging beams and then making double helix and multi-stage imaging.

In the present invention, the optical module of the present embodiment combines the double helix imaging and dual effect of the multi-stage image of the defocus optical grating, the depth of field of the multi-stage imaging is large, the resolution of the double helix imaging is high and has a certain depth of field, during the optical module imaging, on one hand, multi-stage imaging can greatly extend the depth of field, and can be clearly imaged both sides of the object surface, but also the scope of the axial position is further expanded due to double helix effect and further expand the depth of field; on the other hand, the resolution of the double helix imaging is high. In this invention, the image depth of field is up to ten microns or more so as to use for dynamic range imaging of any depth subcellular in the intact cells and obtaining dynamic function images of multiple movement molecules, it has significance meaning for understanding the change relationships and laws of subcellular structure and cell function at a higher level.

### BRIEF DESCRIPTION OF THE DRAWINGS

FIG. 1 is a flow chart of an extended depth of field three-dimensional nano-resolution imaging method in accordance with a first embodiment of the present invention;

FIG. 2 is a contrast chart of double helix point spread function and standard point spread function at different depth;

FIG. 3 is an intensity and phase distribution image of the double helix point spread function;

FIG. 4 is an image pattern of the double helix point spread function in different axial position;

FIG. 5 is a relationship curve between a rotation angle of line of centers of the DH-PSF sidelobes and the Z-axis;

FIG. 6 is an image theory schematic diagram of a defocus optical grating;

FIG. 7 is a schematic diagram of phase plate providing by the first embodiment;

FIG. 8 is an imaging effect diagram of making using of the phase plate in the FIG. 7;

FIG. 9 is a schematic view of an optical component used for extended depth of field three-dimensional nano-resolution imaging in accordance with a second embodiment of the present invention;

FIG. 10 is a schematic view of an extended depth of field super-resolution fluorescence microscopic imaging and detecting system in accordance with a third embodiment of the present invention;

FIG. 11 is a schematic view of another extended depth of field super-resolution fluorescence microscopic imaging and detecting system in accordance with the third embodiment of the present invention.

### DETAILED DESCRIPTION OF THE INVENTION

The realization, functional characteristics, advantages and embodiments of the present invention will be explained below in detail with reference to the accompanying drawings. It is to be appreciated that the following description of the embodiment(s) is merely exemplary in nature and is no way intended to limit the invention, its application, or uses.

The realization of the invention will be explained in detail combining with the embodiments:

### Embodiment One

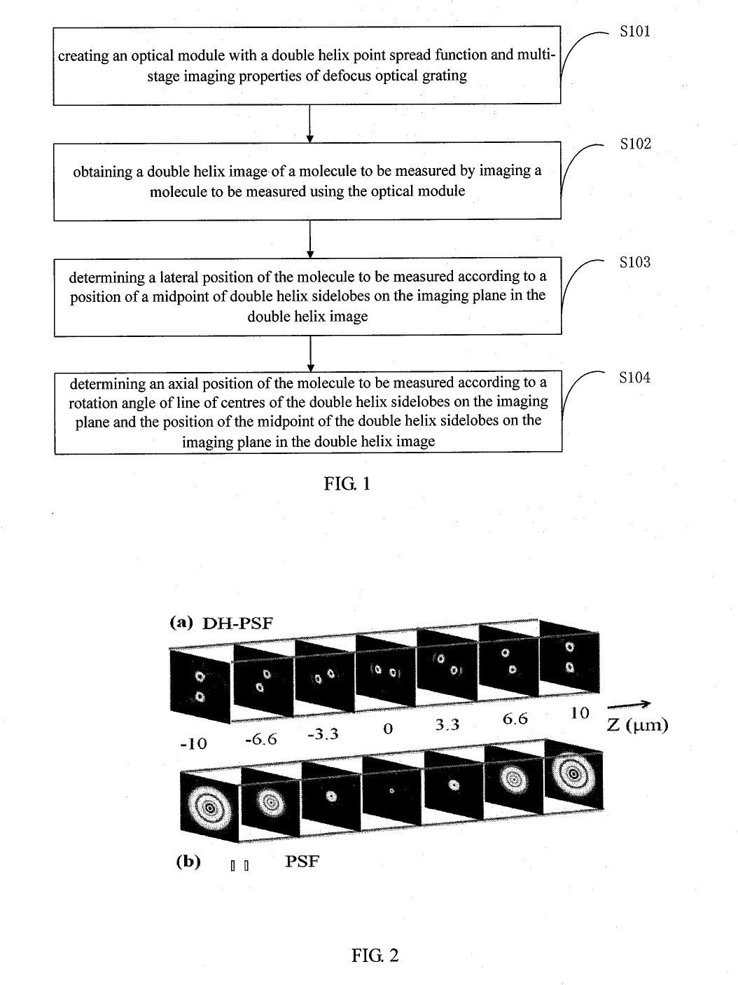

FIG. 1 is a flow chart of the extended depth of field three-dimensional nano-resolution imaging method in accordance with the first embodiment of the present invention, for convenience of description, only relevant parts of the embodiment are shows.

Referring to FIG. 1, the method includes the following steps:

Step S101: creating an optical module with a double helix point spread function and multi-stage imaging properties of defocus optical grating;

Step S102: obtaining a double helix image of a molecule to be measured by imaging a molecule to be measured using the optical module;

Step S103: determining a lateral position of the molecule to be measured according to a position of a midpoint of double helix sidelobes on the imaging plane in the double helix image;

Step S104: determining an axial position of the molecule to be measured according to a rotation angle of line of centers of the double helix sidelobes on the imaging plane and the position of the midpoint of the double helix sidelobes on the imaging plane in the double helix image.

Three-dimensional nano-positioning is based on a phenomenon called self-imaging by the double helix point spread function (DH-PSF). The DH-PSF is a three-dimensional optical response with a circular asymmetric cross-sectional profile constant rotating with the defocus amount, as shown in FIG. 2. A self-imaging beam of rotation and zoom is constituted by the double helix point spread function by linear superposition of LG beam pattern on a specific line in a Laguerre-Gaussian (LG) plane, a composite field in one of the cross-sectionals of the self-imaging beam is used as an optical transfer function of the optical module, so the transfer function of the optical module is the double helix point spread function. The Laguerre-Gaussian beam pattern is as follows:

u_{n,m}(r)=G(\hat{ρ},\hat{z})R_{n,m}(\hat{ρ})Φₘ(φ)Zₙ(\hat{z}) (1)

thereinto, the r=(ρ,φ,z) is a cylindrical coordinate of a spatial point, the \hat{ρ}=ρ/ω(\hat{z}) is a radial coordinate of a gaussian light spot the ω(\hat{z})=ω₀[1+\hat{z}²]^{1/2}, the ω₀ is a waist radius, the \hat{z}=z/z₀ is a longitudinal coordinate, z₀=πω₀²/λ is a Rayleigh length, and the composition of u_{n,m}(r) is:

$$\begin{matrix}G ( \hat{ρ} , \hat{z} ) = \frac{{ω}_{0}}{ω ( \hat{z} )} exp ( - {\hat{ρ}}^{2} ) exp ( i {\hat{ρ}}^{2} \hat{z} ) exp [ - i ψ ( \hat{z} ) ] & ( 2 ) \\ {R}_{n , m} ( \hat{ρ} ) = {( \sqrt{2} \hat{ρ} )}^{\vert m \vert} {L}_{( n - \vert m \vert ) / 2}^{\vert m \vert} ( 2 {\hat{ρ}}^{2} ) & ( 3 ) \\ {Φ}_{m} ( φ ) = exp ( i m φ ) & ( 4 ) \\ {Z}_{n} ( \hat{z} ) = exp [ - i n ψ ( \hat{z} ) ] & ( 5 )\end{matrix}$$

thereinto, the ψ(\hat{z})=arctan(\hat{z}) is a Gouy phase, the L_{(n-|m|)/2}^{|m|} is a generalized Laguerre polynomials, the n,m is an integer, and n=|m|,|m|+2,|m|+4,|m|+6, . . . , and

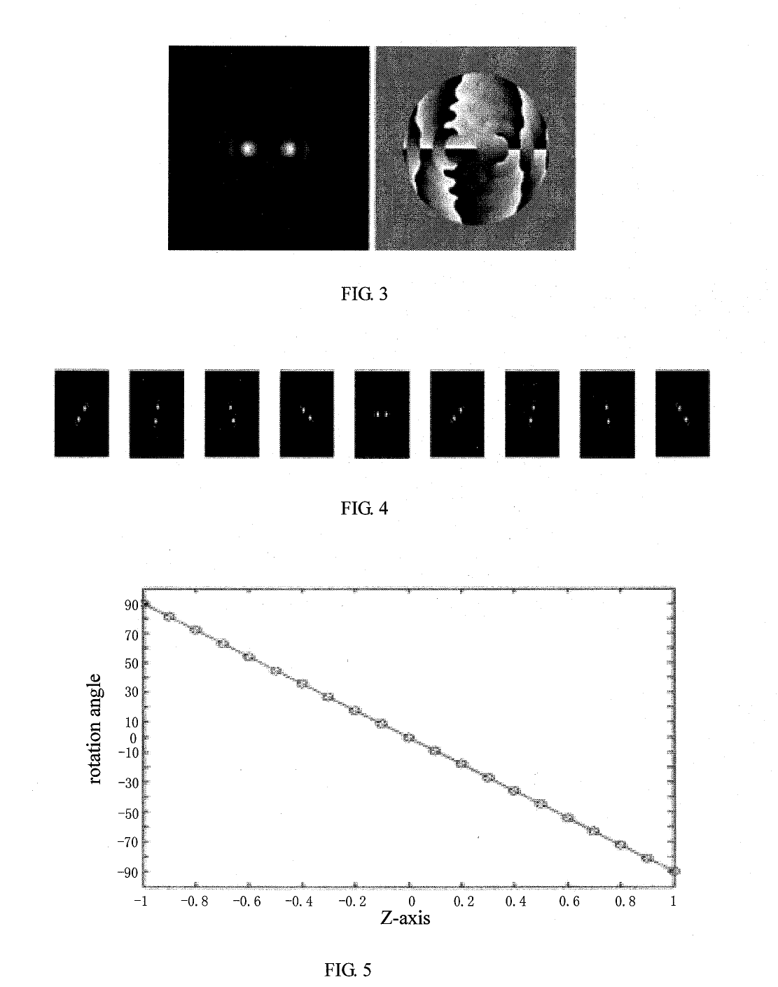

When the values of the n,m are the following five groups: (1, 1), (3, 5), (5, 9), (7, 13), (9, 17), five kinds of Laguerre-Gaussian beam patterns can be obtained. A self-imaging beam of rotation and zoom is formed by equal weighted overlay via the five kinds of Laguerre-Gaussian beams, etc. a new optical field distribution function is formed-double helix rotating beam, shown in FIG. 3. The invariant of the Fourier transform of the LG function based on, if the LG function as an optical transfer function is applied to an optical system, the point spread function of the optical system becomes a double helix point spread function, and the rotating speed of the double helix sidelobes varying with the defocus amount is proportional to the slope of the line selected from the LG model plane, and the speed of the focus area is the maximum, shown in FIG. 4.

A DH-PSF system is a system that an specially designed optical module is added to the Fourier plane of the standard imaging system, the optical module makes the transmittance of the function form double helix formation in the focal region of Fourier transform, the optical module created in step S101 has the characteristic, the images formed by the optical module are two sidelobes rotating with optic axis, wherein, one clockwise rotation around the optical axis, and the other one is counterclockwise. When making three-dimensional nano-positioning with the DH-PSF, the lateral position point of the molecule through is estimated by the midpoint of the sidelobes, and its axial position is determined according to the rotation angle of line of centers of the sidelobes, the position accuracy is high, the relationship curve between the rotation angle of line of centers of the DH-PSF sidelobes and the Z-axis is show in the FIG. 5.

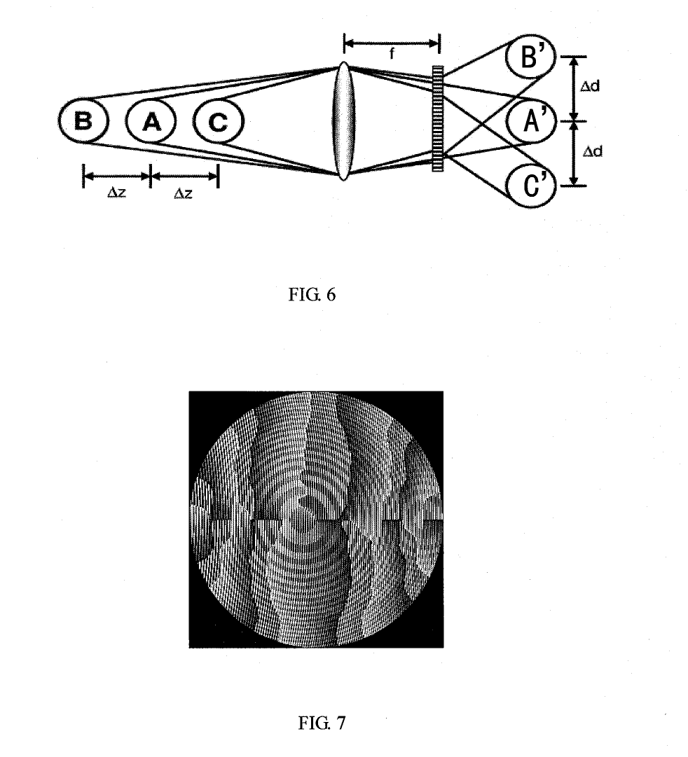

On the other hand, the optical module is also of multi-stage imaging properties of defocus optical grating, the defocus optical grating is essentially an off-axis binary phase Fresnel zone plate, on one hand, it has the spectroscopic effects of a common grating, the incident light is beam splitting on the different diffraction level of the grating; on the other hand, it has the lens action of the Fresnel zone plate, the different lens effects is introduced on the different diffraction level. When the gating is used by close contacting with the short focal length lens, in (1 level diffraction optical axis, fine tuning to the focusing capabilities is done by the defocus optical grating to make the (1 level diffraction light with different focal lengths, respectively, slightly shorter and slightly longer than the lens focal length. The focal plane of the short focal length lens focal on the (1 level diffraction light section is a fore-and-aft symmetrical defocus plane. And the defocus optical grating can image the objects on different object plane in the same plane. Referring to FIG. 6, the object on the point A, B, C of different object plane can image at the A′, B′, C′ of the same plane, the relative distance Δz of the point A, B, C is determined according to the distance Δd among the A′, B′, C′, the depth of field of the defocus optical grating is large, even up to ten microns or more, almost corresponding to the size of the integrity of cells.

The phase grating defocus function is:

$${Φ}_{m} ( X , Y ) = \frac{2 π m {Δ}_{X} ( X , Y )}{d} \qquad ( 6 )$$

Therein,

$$\begin{matrix}{Δ}_{X} ( X , Y ) = \frac{{W}_{20} d}{λ {R}^{2}} ( {x}^{2} + {y}^{2} ) & ( 7 ) \\ {Φ}_{m} ( X , Y ) = m \frac{2 π {W}_{20}}{λ {R}^{2}} ( {x}^{2} + {y}^{2} ) & ( 8 )\end{matrix}$$

wherein, the R is radius of the optical grating; the

$${W}_{20} = \frac{{R}^{2}}{2 mf} ,$$

indicating the defocusing capability of the defocus optical grating, and the standardized coefficients of the defocusing.

Based on the double helix imaging and defocus optical grating imaging properties, in this embodiment, based on the wave front coding method, the double helix point spread function and the defocus optical grating are combined to form a new optical module, the wave front coding is used to use one or more specially designed phase mask to create the method of the optical transfer function of the optical module, such as a lens or the like. In this embodiment, optical module created by means of wave front coding also has the role of the multi focal plane imaging and double helix point spread function. Based on the above description, the phase function of the optical module can be expressed as:

Φₕ=Φ_{db}+Φ_{g}

Thereinto, the Φ_{db} is a complex amplitude phase formed by equal weighted overlay with several kinds of Laguerre-Gaussian beams, the several kinds of Laguerre-Gaussian beams can be the corresponding five kinds of Laguerre-Gaussian beams when the n,m is (1, 1), (3, 5), (5, 9), (7, 13), (9, 17), In this embodiment, the corresponding five kinds of Laguerre-Gaussian beams when the n,m is (1, 1), (3, 5), (5, 9), (7, 13), (9, 17) are equally weighted overlay to form the phase pattern of the double helix rotating beam as the initial value, then the high efficiency of pure phase distribution of the double helix beam is obtained by optimizing.

Beside, the Φ_{g} having the same form with the formula (8), that is the

$${Φ}_{g} = {Φ}_{m} ( X , Y ) = m \frac{2 π {W}_{20}}{λ {R}^{2}} ( {x}^{2} + {y}^{2} )$$

Thereinto, the R is the radius of the optical grating; the

$${W}_{20} = \frac{{R}^{2}}{2 mf}$$

indicating the defocusing capability of the optical module and the standardized coefficients of the defocusing.

Further, the optical module may be a phase plate produced by microfabrication techniques or directly implemented using spatial light modulator.

Further, a lateral position of the molecule to be measured can be determined according to a position of a midpoint of double helix sidelobes on the plane in the double helix image; an axial position of the molecule to be measured can be determined according to a rotation angle of line of centers of the double helix sidelobes on the imaging plane and the position of the midpoint of the double helix sidelobes on the imaging plane in the double helix image.

It can be understood that, during the design of the optical system, the system is pre-calibrated to establish the corresponding relationship between the center position of the double helix sidelobes and the lateral position of the molecule to be measured, and the corresponding relationship between the molecule to be measured and the multi-stage imaging object plane, and the corresponding relationship between the rotation angle of the double helix sidelobes and the defocus amount and so on, the information pre-stored in the database to be called in actual measurement. In actual measurement, according to the concrete position of the midpoint of the two sidelobes of the double helix imaging determine the lateral position of the object point, and initially determine a object point is near the some multi-stage image object plane, and the distance between the object point and the object plane is determined by the rotation angle of the two sidelobes, and then determined the axial position.

In order to verify this method, a preliminary computer simulation verification is made, a diffraction phase plate is design based on the above method, referring to FIG. 7, the imaging method is simulated. The light through diameter of the phase plate: D=5 mm, pixel size: Δ=15 μm; the number of pixels: 336×336, wavelength: λ=670 nm.

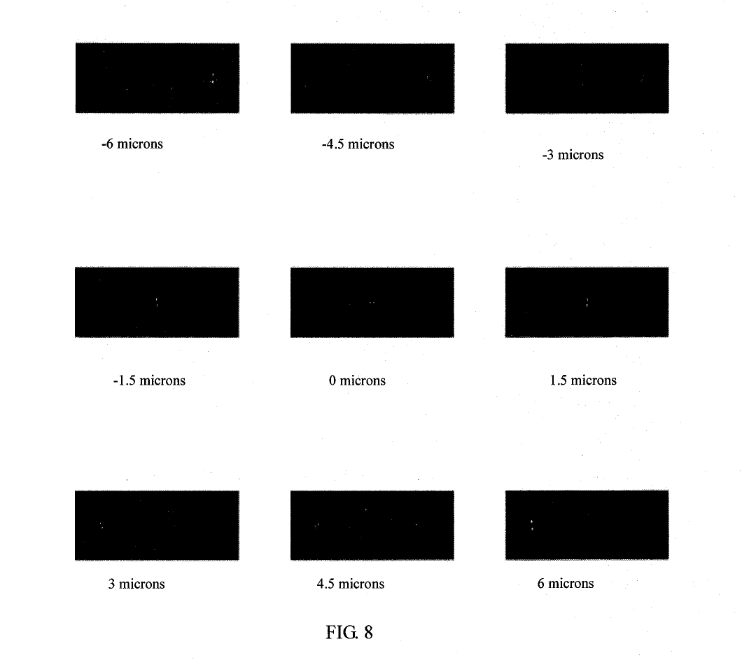

The phase plate is used in the three dimensional imaging system, the image of the particles at different positions is simulated, as shown in FIG. 8. Thus, it can be seen that the imaging range of 12 microns or more can be implemented by the method.

In summary, the optical module of the present embodiment combines the double helix imaging and dual effect of the multi-stage image of the defocus optical grating, the depth of field of the multi-stage imaging is large, the resolution of the double helix imaging is high and has a certain depth of field, during the optical module imaging, on one hand, multi-stage imaging can greatly extend the depth of field, and can be clearly imaged both sides of the object surface, but also the scope of the axial position is further expanded due to double helix effect and further expand the depth of field; on the other hand, the resolution of the double helix imaging is high, in the range of the depth of field, the high resolution axial position of any object point on the object plane can be achieved through the double helix effect to increase the resolution of the three-dimensional imaging. Thus, in this embodiment, the double helix point spread function and the defocus optical grating multi-stage imaging are combined to implement three-dimensional imaging, to extended the depth of field and to improve the resolution. Because the depth of field is up to ten microns so as to use for dynamic range imaging of any depth subcellular in the intact cells and obtaining dynamic function images of multiple movement molecules, it has significance meaning for understanding the change relationships and laws of subcellular structure and cell function at a higher level.

### Embodiment Two

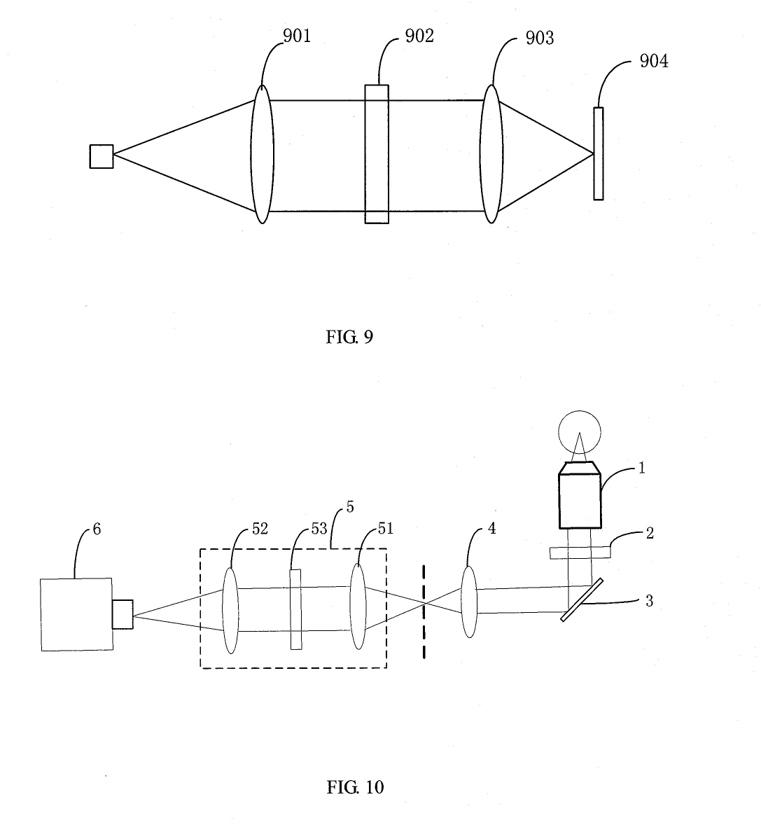

FIG. 9 is a schematic view of an optical component used for extended depth of field three-dimensional nano-resolution imaging in accordance with the second embodiment of the present invention, for convenience of description, only relevant parts of the embodiment are shows.

Based on the extended depth of field three-dimensional nano-resolution imaging method, in the present embodiment, further an optical component is provided for extended depth of field three-dimensional nano-resolution imaging. This component is mainly used for three-dimensional imaging system in order to achieve an extended depth of field and high-resolution of three-dimensional imaging of the cell.

The optical component includes a first lens 901, an optical module 902 and a second lens 903 setting in order along the transmission direction of the optical path. Wherein the optical module 902 has a double helix point spread function and multi-stage imaging properties of defocus optical grating, and is designed based on the above method, and has the function as described in the embodiment one, so it is not repeated here. Typically, the optical system locate and track the molecule by detecting the fluorescence emitted from the molecule to be measured, In the system, the first lens 901 collimate the fluorescence emitted from the molecule to be measured and then output to the optical module 902, the optical module 902 converts the collimated fluorescence to imaging light beams with double helix and multi-stage imaging properties, and then output by the second lens 903, the imaging beam is focused on the image plane of the detector 904, the double helix and multi-stage imaging is realized on the detector. A lateral position of the molecule to be measured can be determined according to a position of a midpoint of double helix sidelobes on the plane in the double helix image; an axial position of the molecule to be measured can be determined according to a rotation angle of line of centers of the double helix sidelobes on the imaging plane and the position of the midpoint of the double helix sidelobes on the plane in the double helix image

In this embodiment, the optical module 902 may specifically be phase plate produced by the photolithography and also can be directly implemented using spatial light modulator, the optical module 902 and the phase function is as the description of the first embodiment, which are omitted here.

### Embodiment Three

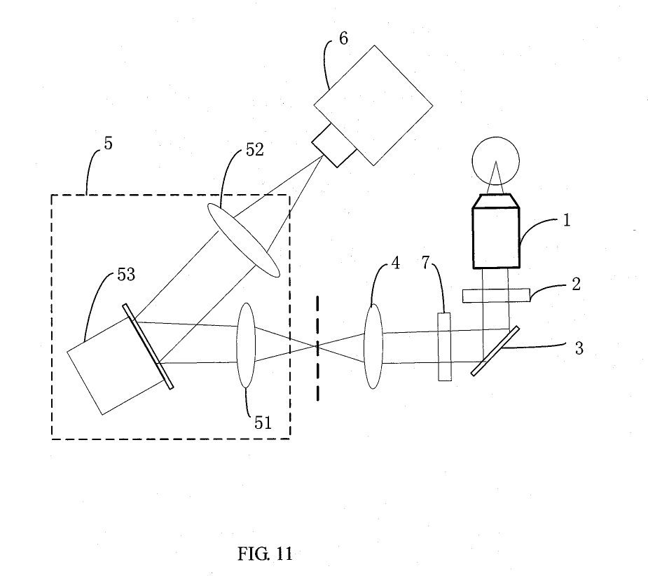

FIG. 10 is a schematic view of an extended depth of field super-resolution fluorescence microscopic imaging and detecting system in accordance with the third embodiment of the present invention, FIG. 11 is a schematic view of another extended depth of field super-resolution fluorescence microscopic imaging and detecting system in accordance with the third embodiment of the present invention, for convenience of description, only a relevant part of the embodiment are shows.

The embodiment of the invention provides an extended depth of field super-resolution fluorescence microscopic imaging and detecting system based on the above imaging method and optical components, the imaging method of the present invention is combined with the super-resolution fluorescence microscopic imaging methods (such as PALM, STORM) to achieve extended depth of field three-dimensional nano-resolution fluorescence microscopic imaging and detecting.

Referring to FIG. 10, the extended depth of field super-resolution fluorescence microscopic imaging and detecting system includes a probing objective lens 1, a filter light sheet 2, a dichroic mirror 3, a tube lens 4, an imaging component 5 and a detector 6 arranged in order along the transmission direction of the optical path. Wherein, the imaging component 5 adopts optical components in the second embodiment. As an implementation, the optical module 53 of imaging component 5 may be a phase plate for converting the collimated fluorescence to imaging light beams with double helix and multi-stage imaging properties.

In this system, the probing objective lens 1 lies in the light outlet side of the object to be measured, the object to be measured can emit fluoresce after excitation light excited, the light beam having excitation light, fluorescence and other stray light is received by the probing objective lens 1, the excitation light, the fluorescence is filtered after the filter action of the filter light sheet 2, the fluorescence is reflected by the dichroic mirror 3 to the tube lens 4 and then focused and transferred to the first lens 51 of the imaging component 5 by the tube lens 4, the fluorescence beam is converted to imaging beams with double helix and multi-stage imaging properties through the phase plate, finally, the fluorescence beams are focused on the imaging plane of the detector 6 to form a double helix image point form on the imaging plane.

As an alternative implementation, shown in FIG. 11, the optical module 53 can also be used to display a phase function of the phase plate adopting a spatial light modulator to achieve the function of the phase plate. At this time, the image system further comprises a polarizing plate 7 arranged between the dichroic mirror 3 and the tube lens 4, and the polarizing plate 7 is used to convert the fluorescence beam to linearly polarized light being adapted to apply the spatial light modulator.

The imaging system can be used for the double helix and multi-stage imaging by the optical component and the imaging method providing by the present invention, making use of the extended depth of field effect and high accuracy axial position of the double helix imaging can realize the extended depth of field and high-resolution of the three-dimensional nano-resolution imaging, and can also achieve dynamic range imaging of any depth subcellular in the intact cells and obtain dynamic function images of multiple movement molecules, which apply to the three-dimensional nano-resolution imaging of intact cells. The extended depth of field imaging three-dimensional nano-resolution imaging system can be used for cell imaging separately and can also be built in the cell imaging, and other imaging devices, and therefore, the imaging devices with the image system are also within the scope of the present invention.

The above-mentioned description is only a preferred embodiment of the present invention, which is not therefore limit the patent range of the present invention. Any equivalent structures, or equivalent processes transform or the direct or indirect use in other related technical fields made by the specification and the FIG. s of the present invention are similarly included the range of the patent protection of the present invention.

1. An extended depth of field three-dimensional nano-resolution imaging method comprising the steps of:
creating an optical module with a double helix point spread function and multi-stage imaging properties of a defocus optical grating;
obtaining a double helix image of a molecule to be measured by imaging a molecule to be measured using the optical module;
determining a lateral position of the molecule to be measured according to a position of a midpoint of double helix sidelobes on the imaging plane in the double helix image; and
determining an axial position of the molecule to be measured according to a rotation angle of a line of centers of the double helix sidelobes on the imaging plane and the position of the midpoint of the double helix sidelobes on the imaging plane in the double helix image.

2. The method as claimed in claim 1, wherein the double helix point spread function of the optical module is realized by the following method:
a self-imaging beam of rotation and zoom is constituted by the double helix point spread function by linear superposition of a Laguerre-Gaussian beam pattern on a specific line lie in a Laguerre-Gaussian plane; and
a composite field in one of the cross-sectionals of the self-imaging beam is used as an optical transfer function of the optical module to make the optical module with the double helix point spread function.

3. The method as claimed in claim 2, wherein the Laguerre-Gaussian beam pattern is:
u_{n,m}(r)=G(\hat{ρ},\hat{z})R_{n,m}(\hat{ρ})Φₘ(φ)Zₙ(\hat{z}),
wherein, r=(ρ,φ,z) is a cylindrical coordinate of a spatial point, the \hat{ρ}=ρ/ω(\hat{z}) is a radial coordinate of a gaussian light spot, ω(\hat{z})=ω₀[1+\hat{z}²]^{1/2}, the ω₀ is a waist radius, the \hat{z}=z/z₀ is a longitudinal coordinate, the z₀=πω₀²/λ is a Rayleigh length, and
the composition of u_{n,m}(r) is:
$$G ( \hat{ρ} , \hat{z} ) = \frac{{ω}_{0}}{ω ( \hat{z} )} exp ( - {\hat{ρ}}^{2} ) exp ( i {\hat{ρ}}^{2} \hat{z} ) exp [ - i ψ ( \hat{z} ) ]$$
$${R}_{n , m} ( \hat{ρ} ) = {( \sqrt{2} \hat{ρ} )}^{\vert m \vert} {L}_{( n - \vert m \vert ) / 2}^{\vert m \vert} ( 2 {\hat{ρ}}^{2} )$$
$${Φ}_{m} ( φ ) = exp ( i m φ )$$
$${Z}_{n} ( \hat{z} ) = exp [ - i n ψ ( \hat{z} ) ] ,$$
wherein, the ψ(\hat{z})=arctan(\hat{z}) is a Gouy phase, the L_{(n-|m|)/2}^{|m|} is a generalized Laguerre polynomials, n,m is an integer, when the values of the n,m are the following five groups: (1, 1), (3, 5), (5, 9), (7, 13), (9, 17), five kinds of Laguerre-Gaussian beam patterns can be obtained; and
a self-imaging beam of rotation and zoom is formed by equal weighted overlay via the five kinds of Laguerre-Gaussian beams.

4. The method as claimed in claim 3, wherein, the phase function of the optical module can be expressed as:
Φₕ=Φ_{db}+Φ_{g}
wherein, the Φ_{db} is a complex amplitude phase formed by equal weighted overlay with the five kinds of Laguerre-Gaussian beams;
$${Φ}_{g} = {Φ}_{m} ( X , Y ) = m \frac{2 π {W}_{20}}{λ {R}^{2}} ( {x}^{2} + {y}^{2} )$$
wherein, the R is radius of the optical grating; the
$${W}_{20} = \frac{{R}^{2}}{2 mf} ,$$
indicating the defocusing capability of the defocus, the optical grating, and the standardized coefficients of the defocusing.

5. The method as claimed in claim 4, wherein, the optical module is a phase plate produced by microfabrication techniques or directly implemented using a spatial light modulator.

6. An optical component used for an extended depth of field three-dimensional nano-resolution imaging, the optical component comprising:
elements arranged in order along the transmission direction of the optical path;
a first lens used for collimating light beams emitted from the molecule to be measured;
an optical module having a double helix point spread function and multi-stage imaging properties of a defocus optical grating and used for converting the light beams to imaging light beams with double helix and multi-stage imaging properties; and
a second lens used for outputting the imaging light beams to image.

7. The optical component as claimed in claim 6, wherein, the phase function of the optical module can be expressed as:
$${Φ}_{h} = {Φ}_{db} + {Φ}_{g}$$
$${Φ}_{g} = {Φ}_{m} ( X , Y ) = m \frac{2 π {W}_{20}}{λ {R}^{2}} ( {x}^{2} + {y}^{2} )$$
wherein, R is the radius of the optical grating;
$${W}_{20} = \frac{{R}^{2}}{2 mf} ,$$
indicating the defocusing capability of the defocus optical grating, and the standardized coefficients of the defocusing;
thereinto, the Φ_{db} is a complex amplitude phase formed by an equal weighted overlay with the five kinds of Laguerre-Gaussian beams;
the Laguerre-Gaussian beam pattern is:
u_{n,m}(r)=G(\hat{ρ},\hat{z})R_{n,m}(\hat{ρ})Φₘ(φ)Zₙ(\hat{z}),
wherein, the r=(ρ,φ,z) is a cylindrical coordinate of spatial point, the \hat{ρ}=ρ/ω(\hat{z}) is a radial coordinate of a gaussian light spot, the ω(\hat{z})=ω₀[1+\hat{z}²]^{1/2}, the ω₀ is a waist radius, the \hat{z}=z/z₀ is a longitudinal coordinate, the z₀=πω₀²/λ is a Rayleigh length,
the composition of u_{n,m}(r) is:
$$G ( \hat{ρ} , \hat{z} ) = \frac{{ω}_{0}}{ω ( \hat{z} )} exp ( - {\hat{ρ}}^{2} ) exp ( i {\hat{ρ}}^{2} \hat{z} ) exp [ - i ψ ( \hat{z} ) ]$$
$${R}_{n , m} ( \hat{ρ} ) = {( \sqrt{2} \hat{ρ} )}^{\vert m \vert} {L}_{( n - \vert m \vert ) / 2}^{\vert m \vert} ( 2 {\hat{ρ}}^{2} )$$
$${Φ}_{m} ( φ ) = exp ( i m φ )$$
$${Z}_{n} ( \hat{z} ) = exp [ - i n ψ ( \hat{z} ) ] ,$$
thereinto, the ψ(\hat{z})=arctan(\hat{z}) is a Gouy phase, the L_{(n-|m|)/2}^{|m|} is a generalized Laguerre polynomials, the n,m is an integer;
the five kinds of Laguerre-Gaussian beam patterns are the corresponding patterns when the values of the n,m are the following five groups: (1, 1), (3, 5), (5, 9), (7, 13), (9, 17).

8. An extended depth of field super-resolution fluorescence microscopic imaging and detecting system, the system comprising:
elements arranged in order along the transmission direction of the optical path;
a probing objective lens used for receiving fluorescence beams emitting from the molecule to be measured;
a light filter used for filtering the beams and then outputting the fluorescence;
a dichroic mirror used for reflecting the fluorescence;
an imaging component, adopting the optical component in claim 6, used for converting the fluorescence beams to imaging beams with double helix and multi-stage imaging properties;
a tube lens used for focusing the reflected fluorescence and transferring it to the imaging component; and
a detector used for receiving the imaging beams and then performing double helix and multi-stage imaging.

9. The system as claimed in claim 8, wherein the optical module in the component is a phase plate produced by microfabrication techniques.

10. The system as claimed in claim 8, wherein the module optical in the component is a spatial light modulator; the system further comprises:
a polarizing plate arranged between the dichroic mirror and the tube lens and used for converting the fluorescence to linearly polarized light being adapted to the spatial light modulator.

11. An extended depth of field super-resolution fluorescence microscopic imaging and detecting system, the system comprising:
elements arranged in order along the transmission direction of the optical path;
a probing objective lens used for receiving fluorescence beams emitting from the molecule to be measured;
a light filter used for filtering the beams and then outputting the fluorescence;
a dichroic mirror used for reflecting the fluorescence;
an imaging component, adopting the optical component in claim 7, used for converting the fluorescence beams to imaging beams with double helix and multi-stage imaging properties;
a tube lens used for focusing the reflected fluorescence and transferring it to the imaging component; and
a detector used for receiving the imaging beams and then performing double helix and multi-stage imaging.
